(19) United States
(12) Patent Application Publication
(10) Pub. No.: US 2016/0090822 A1
(43) Pub. Date: Mar. 31, 2016

(54) COLLISION DETECTION METHOD

(71) Applicant: Schlumberger Technology Corporation, Sugar land, TX (US)

(72) Inventor: Ping Lu, Beijing (CN)

(21) Appl. No.: 14/862,299

(22) Filed: Sep. 23, 2015

Related U.S. Application Data
(60) Provisional application No. 62/055,183, filed on Sep. 25, 2014.

(51) Int. Cl. E21B 41/00; G06F 17/50

(52) U.S. Cl. CPC E21B 41/0092; G06F 17/5004

(57) ABSTRACT

Collision detection may include identifying a planned trajectory of a planned well, selecting offset wells based on the planned trajectory, filtering the offset wells once selected to obtain filtered wells. The filtering includes generating first three dimensional bounding boxes along the planned trajectory. The filtering further includes performing a first removal process including for each offset well in a set of unprocessed wells in the offset wells by: generating second three dimensional bounding boxes along an offset trajectory of the offset well, and filtering the offset well from the offset wells when the first three dimensional bounding boxes satisfy a threshold distance from the second three dimensional bounding boxes. Collision detection may further include presenting at least a subset of the filtered wells.

### CROSS-REFERENCE TO RELATED APPLICATIONS

This application claims priority, pursuant to 35 U.S.C. §119(e), to U.S. Provisional Application No. 62/055,183, filed on Sep. 25, 2014, the entirety of which is incorporated by reference herein.

### BACKGROUND

Operations, such as geophysical surveying, drilling, logging, well completion, and production, are performed to locate and gather valuable downhole fluids from subterranean formations. In order to extract fluids, the trajectories of the wells are carefully determined. Planning the trajectory may include identifying constraints to the trajectory caused by subsurface formations and existence of nearby wells.

### SUMMARY

In general, in one aspect, one or more embodiments relate to collision detection. The collision detection may include identifying a planned trajectory of a planned well, selecting offset wells based on the planned trajectory, filtering the offset wells once selected to obtain filtered wells. The filtering includes generating first three dimensional bounding boxes along the planned trajectory. The first three dimensional bounding boxes each include ellipsoids of uncertainty (EOU) along the planned trajectory. The filtering further includes performing a first removal process including, for each offset well in a set of unprocessed wells in the of offset wells, generating second three dimensional bounding boxes along an offset trajectory of the offset well, where the second three dimensional bounding boxes each include a second EOUs along the offset trajectory, and filtering the offset well from the offset wells when the first three dimensional bounding boxes satisfy a first threshold distance from the second three dimensional bounding boxes. Collision detection may further include presenting at least a subset of the filtered wells.

Other aspects will be apparent from the following description and the appended claims.

### BRIEF DESCRIPTION OF DRAWINGS

FIGS. 1, 2, 3 show schematic diagrams in accordance with one or more embodiments.

FIGS. 4, 5, 6.1, and 6.2 show flowcharts in accordance with one or more embodiments.

FIGS. 7-11 show examples in accordance with one or more embodiments.

FIG. 12 shows a computing system in accordance with one or more embodiments.

### DETAILED DESCRIPTION

Specific embodiments will now be described in detail with reference to the accompanying figures. Like elements in the various figures are denoted by like reference numerals for consistency.

In the following detailed description of embodiments, numerous specific details are set forth in order to provide a more thorough understanding. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments are directed to collision detection between a planned well and an offset well. In one or more embodiments, a collision occurs between the planned well and the offset well when the trajectory of the planned well (i.e., planned trajectory) intersects with the trajectory of the offset well (i.e., offset trajectory). One or more embodiments identify the planned trajectory of a planned well, select offset wells based on the planned trajectory, filter the offset wells to obtain filtered wells, and present at least a subset of the filtered wells. One or more embodiments may identify a planned trajectory of a planned well, select an offset well based on the planned trajectory, and present a user interface showing a three dimensional restricted zone around the offset well for the planned well.

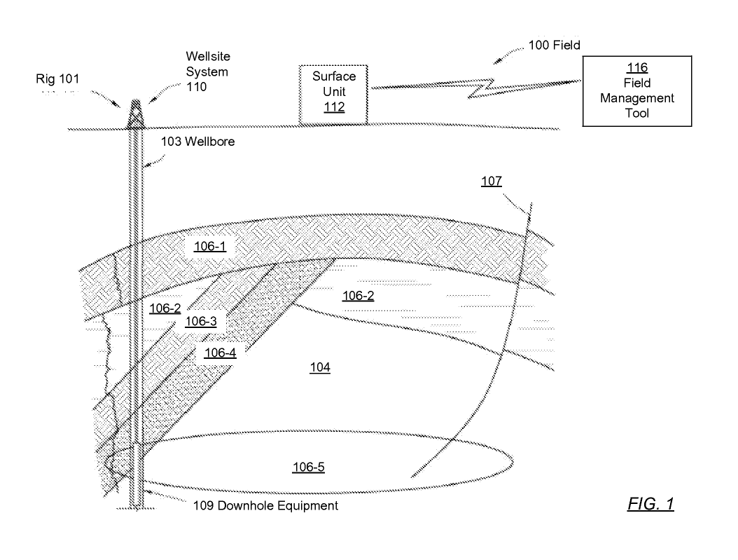

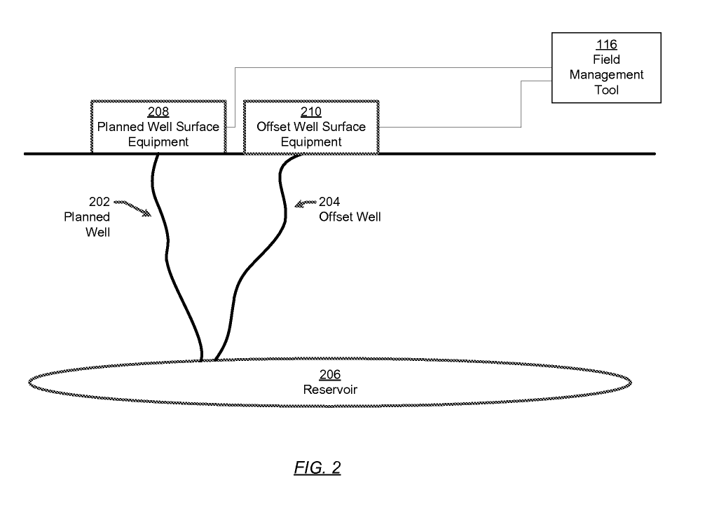

FIG. 1 depicts a schematic view, partially in cross section, of a field (100) in which one or more embodiments may be implemented. In one or more embodiments, the field may be an oilfield. The field may be an onshore or offshore field. In other embodiments, the field may be a different type of field. In one or more embodiments, one or more of the modules and elements shown in FIG. 1 may be omitted, repeated, and/or substituted. Accordingly, embodiments should not be considered limited to the specific arrangements of modules shown in FIG. 1.

As shown in FIG. 1, the subterranean formation (104) may include several geological structures (106-1 through 106-4) of which FIG. 1 provides an example. As shown, the formation may include a sandstone layer (106-1), a limestone layer (106-2), a shale layer (106-3), and a sand layer (106-4). A fault line (107) may extend through the formation. In one or more embodiments, various survey tools and/or data acquisition tools are adapted to measure the formation and detect the characteristics of the geological structures of the formation. Further, as shown in FIG. 1, the wellsite system (110) is associated with a rig (101), a wellbore (103), downhole equipment (109), and other wellsite equipment and is configured to perform wellbore operations, such as logging, drilling, fracturing, production, or other applicable operations to gather downhole fluid from reservoir (106-5). The wellbore (103) may also be referred to as a borehole. Generally, survey operations and wellbore operations are referred to as field operations of the field (100). These field operations may be performed as directed by the surface unit (112). The wellsite system (110) may include specialized equipment for drilling the well along a planned trajectory.

In one or more embodiments, the surface unit (112) is operatively coupled to a field management tool (116) and/or the wellsite system (110). In particular, the surface unit (112) is configured to communicate with the field management tool (116) and/or the wellsite system (110) to send commands to the field management tool (116) and/or the wellsite system (110) and to receive data therefrom. For example, the wellsite system (110) may be adapted for measuring downhole properties using logging-while-drilling (“LWD”) tools to obtain well logs and for obtaining core samples. In one or more embodiments, the surface unit (112) may be located at the wellsite system (110) and/or remote locations. The surface unit (112) may be provided with computer facilities for receiving, storing, processing, and/or analyzing data from the field management tool (116), the wellsite system (110), or other parts of the field (100). The surface unit (112) may also be provided with or functionally for actuating mechanisms at the field (100). The surface unit (112) may then send command signals to the field (100) in response to data received, for example to control and/or optimize various field operations described above.

In one or more embodiments, the data received by the surface unit (112) represents characteristics of the subterranean formation (104) and may include seismic data and/or information related to porosity, saturation, permeability, natural fractures, stress magnitude and orientations, elastic properties, etc. during a drilling, fracturing, logging, or production operation of the wellbore (103) at the wellsite system (110).

In one or more embodiments, the surface unit (112) is communicatively coupled to the field management tool (116). Generally, the field management tool (116) is configured to analyze, model, control, optimize, or perform other management tasks of the aforementioned field operations based on the data provided from the surface unit (112). Although the surface unit (112) is shown as separate from the field management tool (116) in FIG. 1, in other examples, the surface unit (112) and the field management tool (116) may also be combined.

The surface unit (112) and field management tool (116) may be connected to multiple wells. In particular, the configuration shown in FIG. 1 may be present at multiple wells throughout a field. FIG. 2 shows an example of a field in accordance with one or more embodiments. As shown in the example, the field may include a planned well (202) and an offset well (204). The planned well (202) and the offset well (204) may be planned to be connected to a same reservoir (206) or to different reservoirs having fluids. Further, the planned well (202) and the offset well (204) may also be connected to various surface equipment (e.g., planned well surface equipment (208), offset well surface equipment (210)) and subsurface equipment (not shown). The equipment may be the same or different equipment for the planned well and offset well(s).

A planned well (208) is a well that is being planned in accordance with one or more embodiments. In particular, the trajectory of the planned well is being planned. The trajectory may follow any of a variety of paths to the reservoir, and may change as the planned well is being planned. For example, the planned well may follow a straight path or meander in one or more directions to the reservoir.

An offset well (210) is any well that may interfere with the planned well (208). Specifically, an offset well is any well that is identified as a possible source of collision with the planned trajectory of the planned well.

The planned well and/or one or more of the offset wells may have one or more horizontal sections. In the horizontal section, the wellbore's departure from vertical exceeds approximately 80 degrees. The planned well and/or one or more of the offset wells may have one or more vertical sections. In the vertical section, the wellbore is at least within 80 degrees to the vertical.

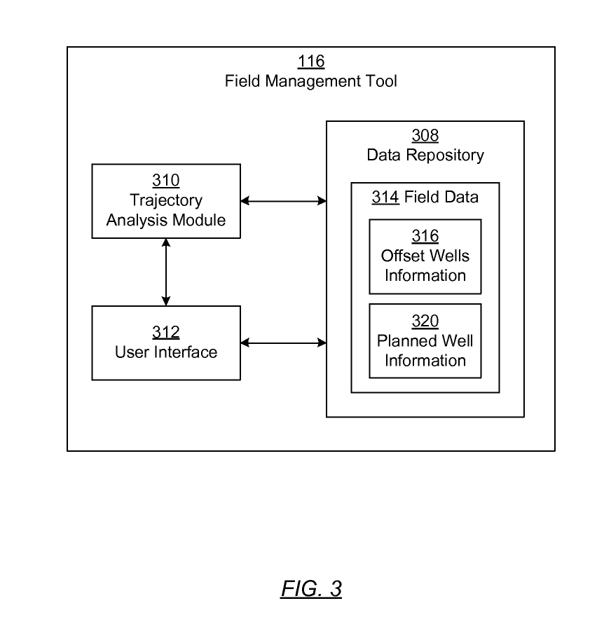

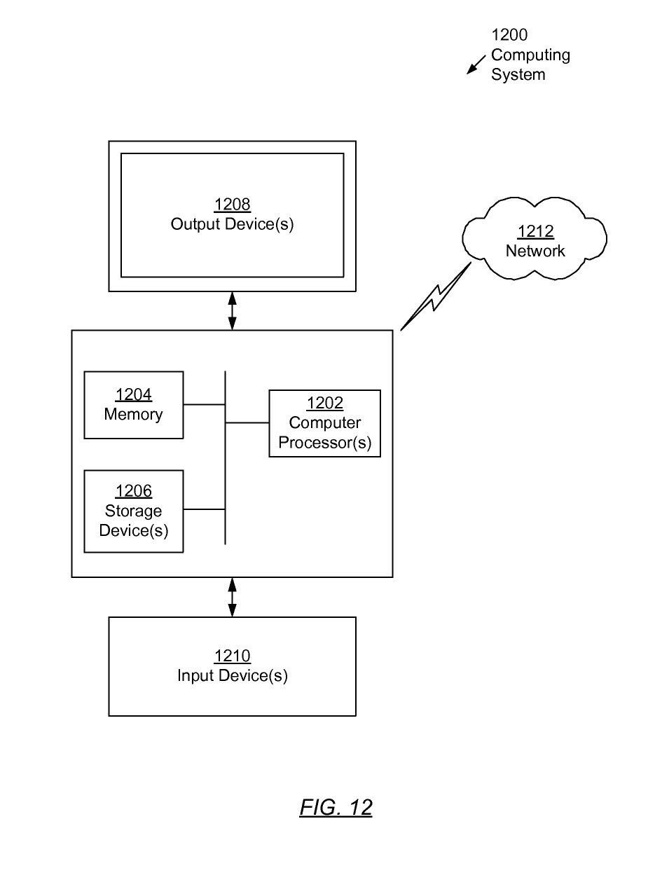

FIG. 3 shows a schematic diagram of a system in accordance with one or more embodiments. As shown in FIG. 3, the field management tool (116) is a tool that is configured to perform management operations of the field. In some embodiments, the field management tool (116) may be a software tool configured to execute on a computing system, such as the computing system shown in FIG. 12. In some embodiments, the field management tool (116) may be a hardware tool, such as a computing system, and may or may not include specialized equipment for management of the field. The field management tool (116) includes a data repository (308), a trajectory analysis module (310), and user interface (312) in accordance with one or more embodiments. Each of these components is described below.

In one or more embodiments, the data repository (308) is any type of storage unit and/or device (e.g., a file system, database, collection of tables, or any other storage mechanism) for storing data. Further, the data repository (308) may include multiple different storage units and/or devices. The multiple different storage units and/or devices may or may not be of the same type or located at the same physical site.

The data repository (308) includes functionality to store field data (314). Field data (314) is any type of data from the field, such as the field shown in FIGS. 1 and 2. For example, field data (314) may include sensor data, offset well information (316) and planned well information (318). Well information is any type of information about the offset wells and planned well, respectively. For example, the offset well information and planned well information may include trajectory information about the respective well. The trajectory information defines the paths of one or more offset wells. The trajectory information may also define at least one path of a planned well. In other words, the trajectory information is data describing the particular paths through the underground formation of one or more offset wells and the planned well.

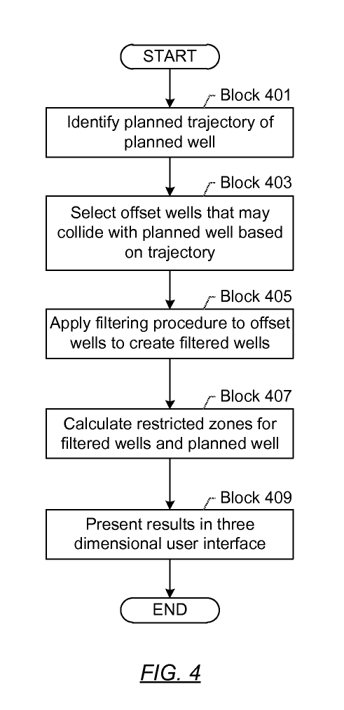

Continuing with FIG. 3, the trajectory analysis module (310) includes functionality to assist planning the planned trajectory. For example, the trajectory analysis module (310) may include functionality to analyze offset trajectories and a planned trajectory, perform any filtering, and perform collision detection based on the trajectories. With the exception of the blocks involving the use of the user interface (312), the trajectory analysis module may include functionality to perform the blocks of FIGS. 4, 5, 6.1 and 6.2.

The user interface (312) includes functionality to present data to a user and receive commands from a user. The user interface (312) includes functionality to present the trajectory to a user. In particular, the user interface (312) may include functionality to present a three dimensional rendering of the trajectories for collision detection. The user interface (316) may further include functionality to receive approval and parameters from a user. Although not shown in FIG. 3, the user interface (316) may include graphical user interface widgets, such as drop down boxes, selection boxes, and other such widgets to receive input from a user. The user interface may also include a pane or window that displays trajectory information in three dimensions, whereby a user may drag the display to view different portions of the well plan. Various types of user interfaces exist that may be used without departing from the scope of the collision detection method.

The field management tool (116) may include other modules such as a modeling module for modeling one or more aspects of the subsurface formations and performing wellsite planning. The field management tool may include a field control module that includes functionality to drill the planned well based on the collision detection analysis. For example, the field control model may include functionality to send control signals to the planned wellsite equipment to change various aspects of the drilling operations, such as mud weight, choke positions, and other configurable elements of the drilling equipment. The field control model may further include functionality to start or stop drilling operations.

While FIG. 3 shows a configuration of components, other configurations may be used without departing from the scope of the collision detection method. For example, various components may be combined to create a single component. As another example, the functionality performed by a single component may be performed by two or more components.

While FIGS. 1-3 show a configuration of components, other configurations may be used without departing from the scope of the collision detection method. For example, various components may be combined to create a single component. As another example, the functionality performed by a single component may be performed by two or more components.

FIGS. 4, 5, 6.1 and 6.2 show flowcharts in accordance with one or more embodiments. While the various blocks in these flowcharts are presented and described sequentially, one of ordinary skill will appreciate that at least some of the blocks may be executed in different orders, may be combined or omitted, and at least some of the blocks may be executed in parallel. Furthermore, the blocks may be performed actively or passively. For example, some blocks may be performed using polling or be interrupt driven in accordance with one or more embodiments. By way of an example, determination blocks may not require a processor to process an instruction unless an interrupt is received to signify that condition exists in accordance with one or more embodiments. As another example, determination blocks may be performed by performing a test, such as checking a data value to test whether the value is consistent with the tested condition in accordance with one or more embodiments.

In Block 401, a planned trajectory of the planned well is identified in accordance with one or more embodiments. In one or more embodiments, the graphical user interface receives a selection of a predefined trajectory. For example, using a mouse, keyboard, touch screen input device, etc., the user may input a command to select a displayed trajectory. The command may cause the input device to notify the device driver of the input device, which triggers an event to the computing device processor. The computing device processor determines the currently active application and notifies the currently active application with parameters describing the input. In turn, the currently active application, using standard library code, interprets the notification with parameters of the portion of the input as a selection in the graphical user interface, and, based on the selection, identifies the selected planned well. Using a similar technique, the user interface may receive information about a file, such as from a file menu or text box displayed in the graphical user interface. In one or more embodiments, a user may interactively submit the trajectory information for the planned well. For example, the user may use a well planning application, such as a user, via the user interface, may submit a trajectory for the planned well. The trajectory may be submitted interactively using the graphical user interface, such as by using drilling simulation software.

In Block 403, offset wells that may collide with the planned well are selected based on the trajectory in accordance with one or more embodiments. The initially selected offset wells include offset wells that are in the geographic region of the planned well. For example, offset wells, which are on the other side of the world, may not be selected. In some embodiments, an initial filtering removes wells that are more than a threshold distance away from the planned well. For example, the threshold distance may be the total length of the longest well multiplied by a constant, such as two, three, etc. By way of an example, the initial filtering may remove wells that are more than fifty miles away.

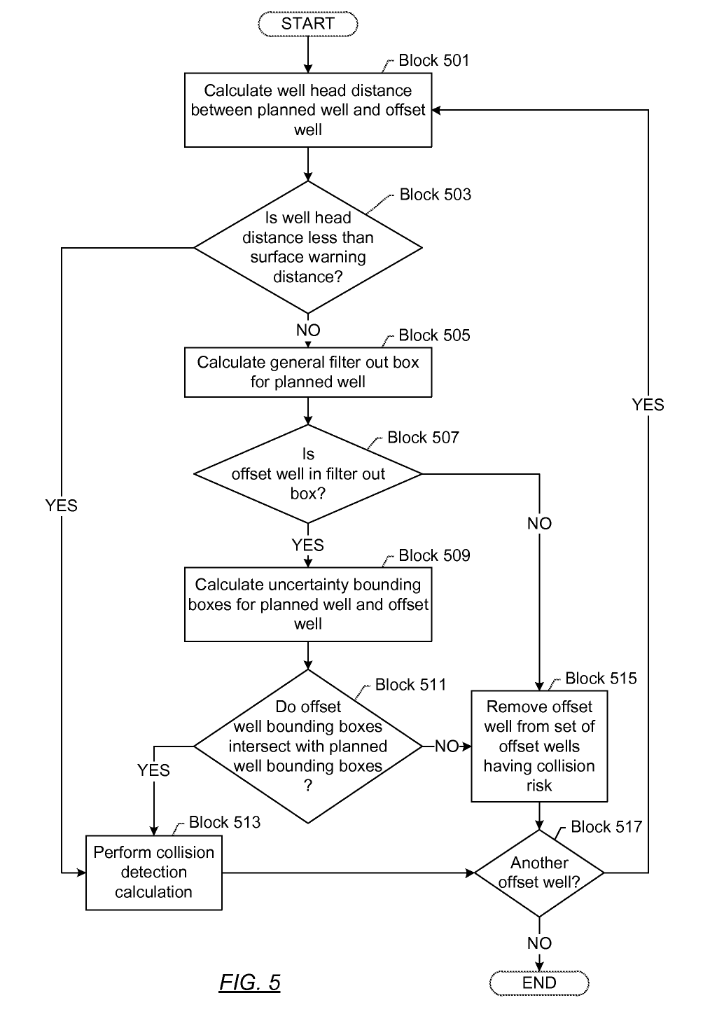

In Block 405, a filtering procedure is applied to the offset wells to create filtered wells in accordance with one or more embodiments. In particular, the filtering reduces the number of offset wells to consider when performing collision detection. FIG. 5 shows a flowchart for performing a filtering procedure in accordance with one or more embodiments.

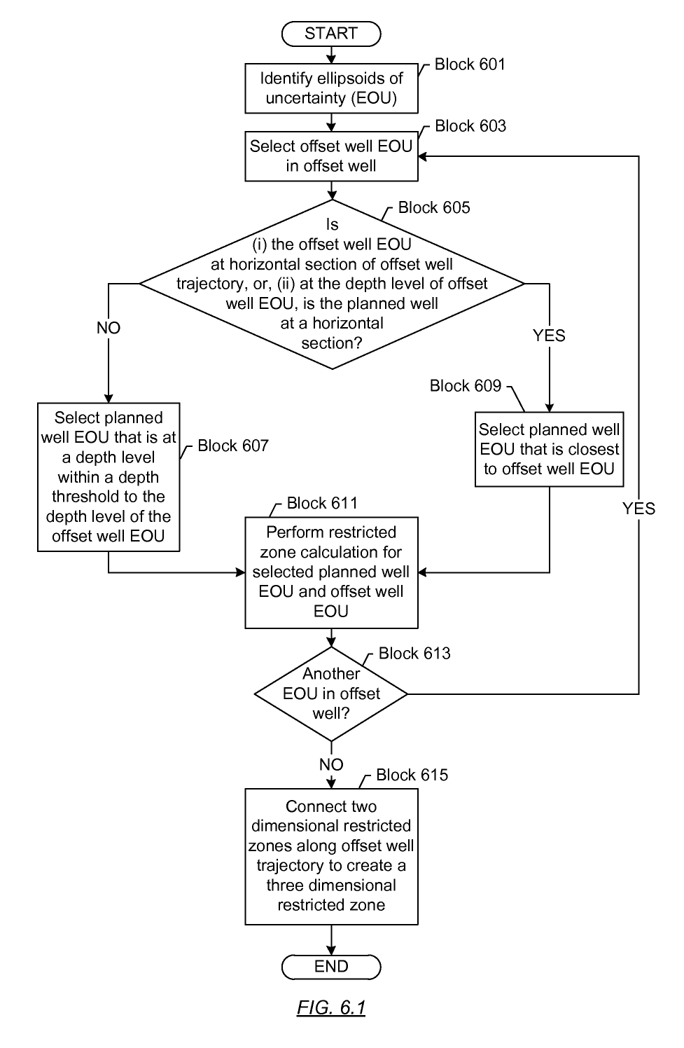

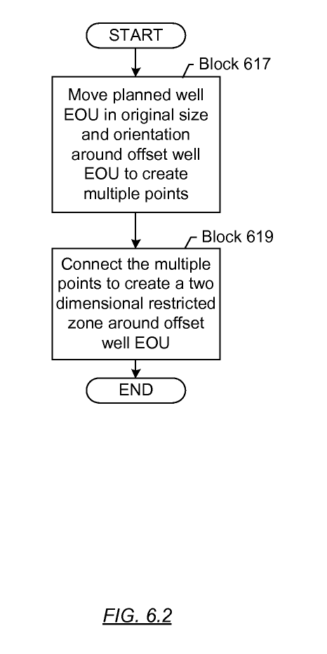

Continuing with FIG. 4, in Block 407, possible collisions between the filtered wells and the planned well are calculated. The collision detection determines whether any intersect exists between the planned well and the filtered offset wells. Performing collision detection to determine intersect may be performed using techniques known in the art. For example, the collision detection may compare each portion of the trajectories to determine whether an intersection exists. In one or more embodiments, the collision detection may further include a restricted region analysis to identify restricted regions around the filtered offset wells for the planned well. The restricted regions are regions that are around the offset well, which are restricted from having even a portion of the planned well. For example, the restricted regions may represent areas of uncertainty with respect to the drilling location. By way of another example, drilling and/or production in or through the restricted regions may cause degradation in structural integrity of the offset well and/or planned well. In one or more embodiments, collision detection is performed on a per offset well basis. Thus, if multiple offset wells exist, the collision detection procedure may be performed for each offset well. The restricted region analysis of Block 407 may be performed using the flowcharts of FIGS. 6.1 and 6.2.

In Block 409, results of the calculations are presented in accordance with one or more embodiments. In one or more embodiments, the results are presented as a three-dimensional rendering of the offset well and the planned well. The three dimensional rendering may include a rendering of the trajectory and restricted regions. Further, a user may use one or more graphical user interface widgets, or select and move, while selected, the three dimensional rendering to view the rendering at different angles. Receiving the selection and movement may be performed as discussed above with reference to Block 401 of FIG. 4. A user using the user interface may adjust the trajectory of the three dimensional rendering in order to avoid collisions and the restricted regions in accordance with one or more embodiments. Thus, the user may dynamically update the trajectory for the well.

Based on the analysis, a field operation may be performed. For example, the field management tool may instruct the field equipment to drill the planned well based on the analysis. In response, the field equipment may perform drilling operations.

FIG. 5 shows a flowchart for filtering offset wells in accordance with one or more embodiments. Initially, an offset well is selected (not shown) in accordance with one or more embodiments. In particular, the Blocks of FIG. 5 may be performed for each offset well in the set of offset wells to consider. In Block 501, the well head distance between the planned well and the offset well is calculated in accordance with one or more embodiments. The well head of the well is the portion of the well that is at the surface (e.g., of the Earth, ocean floor, etc.). Calculating the well head distance may include identifying the locations of the well head of the planned well and the well head of the offset well. Standard distance calculations that use a planar approximation of the Earth (e.g., treat the Earth as flat) may be used in accordance with one or more embodiments. In other embodiments, formulas, such as the haversine formula, or a formula that treats the Earth as spherical, may be used to calculate the well head distance.

In Block 503, a determination is made whether the well head distance is less than the surface warning distance in accordance with one or more embodiments. In one or more embodiments, the surface warning distance is a maximal distance for which the collision detection calculation is automatically performed without further filtering. The surface warning distance may be pre-defined within the software, by a user, or by another component. In one or more embodiments, a small surface warning distance may increase the amount of wells that are processed through later filtering and ultimately have collision detection determined. A surface warning distance that is too large may have collision detection calculation performed for too many wells. Block 503 may be performed by issuing an instruction to compare two numbers, such as to the arithmetic logic unit of the computing device processor. If the well head distance is less than the surface warning distance, the flow proceeds to Block 513 for the well. In other words, collision detection calculation may remain in the set or is added to a set, or otherwise marked for collision detection calculation.

Returning to Block 503, if the well head distance is not less than the surface warning distance, then a filter out box is calculated for the planned well and offset well in Block 505. In particular, the bounding box of the planned well is calculated and projected onto the surface. The bounding box is the smallest box that fits the entire planned well. Calculating the bounding box and projecting onto the surface may include determining, for each of two directions of the surface (not including depth), two points that are the maximum distance of the planned well in the particular direction. Further, in the two directions, the total measured depth of the offset well is added.

In Block 507, a determination is made whether the offset well is in the filter out box in accordance with one or more embodiments. In other words, the offset well may be projected onto the surface to determine whether any portion of the offset well is in filtered out box. If the offset well is not in the filtered out box, then, in Block 515, the offset well is removed from the set of offset wells having collision risk. Removing the offset well may include setting a value associated with the offset well to indicate to not perform collision detection calculation, adding the offset well to a data structure, removing the offset well from a data structure, or ignoring the offset well.

Returning to Block 507, if the offset well is in the filter out box, then the flow proceeds to Block 509. In Block 509, uncertainty bounding boxes for the planned well and the offset well are calculated in accordance with one or more embodiments. In one or more embodiments, calculating the uncertainty bounding boxes for a well may be performed as follows.

Initially, ellipsoids of uncertainty are calculated. Calculating the ellipsoids of uncertainty (EOU) may be performed as described in A. Jamieson, et al., Introduction to Wellbore Positioning, University of the Highlands and Islands, Version 01.7.12 (2012) and in H. S. Williamson, Accuracy Prediction for Directional Measurement While Drilling, SPE Drill and Completion (15) (4) (December 2000). Using the EOU, a unique bounding box is created for each EOU. Adjacent bounding boxes may intersect, may have common edges, or may be spaced apart. The bounding box is the minimum box surrounding the EOU, such that two EOUs with such boxes that are apart from each other will not trigger collision detection warning according to the anti-collision rule. In other words, two adjacent bounding boxes that are spaced apart on the trajectory are each not so small that the possibility of collision should be detected.

In one or more embodiments, multiple parameters may be used to determine the single bounding box around one given EOU. The parameters may be configured in the anti-collision rule. For example, the parameter may be minimum allowed separation factor, which is described in Introduction to Wellbore Positioning (identified above). In one or more embodiments, if the minimum allowed separation factor is five, then the bounding box size is five times the size of the smallest box that can surround the EOU. Another parameter may be a warning distance between planned well trajectory and offset well trajectory. Using the a warning distance is performed by dividing the warning distance by two to obtain a result. The bounding box using any other parameter should extend in each direction at least by the result. If the bounding box does not extend in each direction at least by the result, then the bounding box is increased to extend in each direction by the result. By way of an example, if the a warning distance is fifteen, then the bounding box should extend in each of the six directions (x+, x−, y+, y−, z+, z−) at least 7.5 (i.e., 15/2). If the bounding box calculated using the minimum allowed separation factor does not extend by 7.5 in each of the six directions, then the bounding box is increased to extend in the each of six directions by 7.5. If the bounding box calculated using the minimum allowed separation factor does extend by at least 7.5 in each of the six directions, then the box calculated using the minimum allowed separation factor is used.

After generating bounding boxes, the bounding boxes around a single EOU (i.e., single EOU bounding boxes) are combined into bigger bounding boxes (i.e., multi-EOU bounding boxes). In one or more embodiments, each pair of adjacent multi-EOU bounding boxes may have a common EOU (i.e., an EOU that is in both adjacent bounding boxes). Thus, the multi-EOU bounding boxes intersect and span the trajectory. In one or more embodiments, a predefined number of single EOU bounding boxes are combined into the multi-EOU bounding boxes. For example, every four adjacent single EOU bounding boxes may be combined into a multi-EOU bounding box, where the top and bottom single EOU bounding boxes are in two multi-EOU bounding boxes. In one or more embodiments, the multi-EOU bounding boxes may be further combined based on being within a threshold distance from each other in the z-direction (i.e., the true vertical depth direction). For example, the threshold distance may be twenty meters. In other words, the adjacent multi-EOU bounding boxes combined have a true vertical depth that is less than a threshold. Thus, in one or more embodiments, horizontal sections of the well may have multiple multi-EOU bounding boxes combined. In one or more embodiments, more than two adjacent multi-EOU bounding boxes may be combined.

In one or more embodiments, a further refinement may be performed to remove intersections between the adjacent bounding boxes. For example, for the lowest two bounding boxes, one intersection in z direction exists. The intersection of the upper box may be removed, and the lower box may be expanded to include the intersection. The expansion may be performed to include the intersection as well as retain the box structure. A similar operation may be performed for the next two adjacent pair of bounding boxes, whereby, for a pair, the section from the upper box that is in the intersection is removed, and the lower box expanded to include the section in the intersection. The use of the terms upper and lower is with respect to measured depth in accordance with one or more embodiments. Rather than adding the intersection to the lower bounding box, the intersection may be added to the upper bounding box. By performing the operation of combining bounding boxes, one or more embodiments may increase speed of filtering.

Further, although FIG. 5 shows performing the bounding box calculation each time for the planned well, the bounding box calculation may be performed once for the each well.

Continuing with FIG. 5, in Block 511, a determination is made whether the offset well bounding boxes intersect with the planned well bounding boxes. In other words, the determination is made whether, after refinement, the multi-EOU bounding boxes of the offset well overlap with the multi-EOU bounding boxes of the planned well. The determination may be performed as follows. A pair of bounding boxes, one from the offset well and one from the planned well, are selected that intersect with respect to true vertical depth dimension. The remaining dimensions of the selected wells are compared to determine whether both of the remaining dimensions of the bounding boxes intersect. If the selected bounding boxes intersect, then the well is determined to have possible collisions. Once a possible collision is detected, the processing may stop. In other embodiments, the processing may continue to identify each possible collision. If the selected bounding boxes do not intersect, the flow may repeat to select the next pair of bounding boxes that intersect with respect to true vertical depth for comparison. The above is one algorithm that may be used to determine whether bounding boxes intersect. Various algorithms may be used to determine whether boxes intersect in three dimensional space without departing from the scope of the collision detection method.

If, in Block 511, a determination is made that the offset well bounding boxes and the planned well bounding boxes intersect, then the method flows to Bock 513 to perform collision detection calculation on the offset well. If, in Block 511, a determination is made that the offset well and planned well do not have any intersecting bounding boxes, then the flow proceeds to Block 515 to remove the offset well from the set of offset wells having collision risk. In other words, the offset well is filtered from the set of wells that may collide with the planned well.

Regardless of whether Block 513 or Block 515 is performed, the flow may proceed to Block 517 to determine whether another offset well exists that is unprocessed. If another offset well exists, the flow may proceed to Block 501, to determine whether to filter the next offset well.

When Block 517 completes, if an offset well is determined to have risk, standard collision detection analysis may be performed to determine the risk for collisions. In other words, the filtering of the wells may stop and standard collision detection may be performed. Wells that are deemed to have greater possibility of collision may have restricted zones defined for the wells.

Turning to FIGS. 6.1 and 6.2, FIGS. 6.1 and 6.2 show flowcharts for identifying the restricted zones around an offset well when potential collision may occur. In Block 601 of FIG. 6.1, EOUs for both the planned well and the offset well are identified. Identifying the EOUs may be performed as discussed above with reference to FIG. 5.

In Block 603, an offset well EOU in the offset well is selected in accordance with one or more embodiments. In one or more embodiments, the flow may iterate through the EOUs for the offset well to identify the restricted zone. Any unprocessed offset well EOU may be selected for processing in accordance with one or more embodiments.

In Block 605, a determination is made whether (i) the offset well EOU is at a horizontal section of offset well trajectory, or, (ii) at the depth level of offset well EOU, the planned well is at a horizontal section. In other words, the determination is made whether the offset well or the planned well is at a horizontal section at the offset well EOU or at the depth of the offset well EOU in the case of the planned well. As discussed above, determining whether a well is at a horizontal section may be performed by determining the amount of deviation of the offset well from the true vertical depth direction. If the amount of deviation satisfies a horizontal deviation threshold, then the well is determined to be at the horizontal section of the trajectory.

If neither condition of block 605 is satisfied, the flow proceeds to block 607. In Block 607, a planned well EOU that is at a true vertical depth within a depth threshold to the true vertical depth of the offset well is selected. In other words, the selected planned well EOU has at least substantially the same true vertical depth value as the offset well EOU. The selected planned well EOU and offset well EOU may be processed in Block 611.

Returning to Block 605, if either condition or both conditions of block 605 are satisfied, the flow proceeds to Block 609. In Block 609, the planned well EOU that is closest to the offset well EOU is selected in accordance with one or more embodiments. In one or more embodiments, deviation, when either or both wells are at a horizontal section may cause a collision at the location of the closest EOUs. Thus, the distance between the offset well EOU and each planned well EOU is calculated to determine which planned well EOU has the minimal distance to the offset well EOU in accordance with one or more embodiments. The planned well that has the minimal distance is selected as the selected planned well EOU and processed in Block 611.

In Block 611, a restricted zone calculation is performed for the selected planned well EOU and offset well EOU. The restricted zone calculation is described in FIG. 6.2. Turning to FIG. 6.2, in Block 617, the planned well EOU is moved around the offset well EOU to create multiple points. In other words, the planned well EOU is moved along a plane that is perpendicular to the length of the trajectory. Thus, the planned well EOU is moved in two dimensional space around the offset well EOU. In one or more embodiments, the planned well EOU stays in the same size and orientation when moved around the offset well EOU. Then, the minimum allowed separation distance (MASD) is calculated in some directions, which may be configured in the system, around the offset well EOU. The MASD means, given the anti-collision rule, if the least distance between the planned well trajectory and the offset well trajectory at the given depth is smaller than the MASD, then an anti-collision warning should be given. In other words, the anti-collision warning is a warning to a user and/or system that a collision between the wells may occur. Calculating the MASD may be from the size and orientation of both planned well EOU and offset well EOU, the direction of the line connecting the two EOU centers (the distance between 2 EOUs may not be used for the calculation), and the anti-collision rule configured by the user. Due to the shape of EOU, at a given depth of offset well, the MASD may vary at different directions. So, at each direction around the offset well EOU, MASD is calculated, then the MASD point in the particular direction is determined by having the point apart from the trajectory point for the distance of MASD. The restricted zone at the particular depth is made by connecting the MASD points.

Continuing with FIG. 6.2, in Block 619, the multiple points are connected to create a two dimensional restricted zone around the offset well EOU. Connecting the points may be performed by calculating a straight or curved line that connects adjacent points. In other words, Block 617 may be used to identify several points and Block 619 may be used to connect the points. Because the planned well EOU and offset well EOU are ellipsoids, the shape around the offset well EOU may be irregular.

The three dimensional restricted zone is made by connecting the two dimensional restricted zones. To keep the planned well safe in terms of anti-collision is to keep the planned well trajectory out of any restricted zone, but not to keep the planned well EOUs out of the restricted zones in accordance with one or more embodiments of the invention.

Returning to FIG. 6.1, a determination is made whether another EOU in the offset well exists that is unprocessed in Block 613. If another unprocessed EOU exists, the flow may return to Block 603 to select the next offset well EOU. While or after processing EOU wells, the flow may proceed to Block 615.

In Block 615, the two dimensional restricted zones are connected along the offset well trajectory to create a three dimensional restricted zone. In other words, for each adjacent offset well EOU, creating the three dimensional space may be performed as follows. For each point, on a two dimensional restricted zone, the corresponding matching point is identified based on having the same angular offset from a based angle of the trajectory. A line is created that connects the two points along the trajectory. As the trajectory may curve, the line may curve as well. Thus, an irregular three dimensional shape may be created having an irregular cross section. By allowing for irregular cross sections, one or more embodiments may create a restricted zone that accurately reflects the shape of the borehole.

One or more embodiments may be used to alleviate or remove the probability of missing an offset well with respect to collision detection risk, while at the same time filtering out non-risky offset wells in a fast manner. For example, in some embodiments, five thousand wells may be filtered out in less than or equal to approximately two seconds.

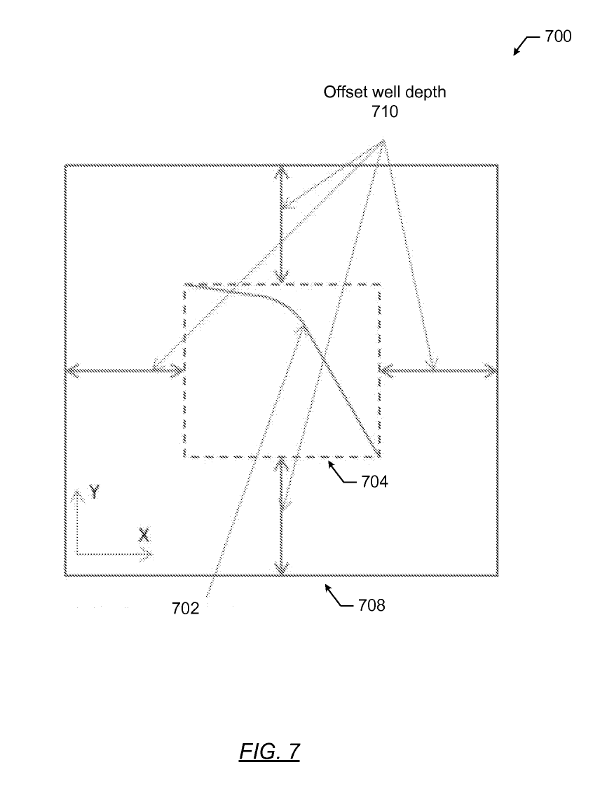

FIG. 7 shows a schematic diagram (700) of an initial filtering by creating a filter out box in accordance with one or more embodiments. Specifically, FIG. 7 shows an example of the filtering in Block 501 of FIG. 5. In FIG. 7, the planned well trajectory (702) is projected onto the horizontal plane, such as the surface of the earth. A two dimensional bounding box (704) is added around the planned well trajectory, such that the size of the two dimensional bounding box is the minimal size that fits the planned well. Further, the offset well depth (710) may be added in the four directions around the two dimensional bounding box. In one or more embodiments, the offset well depth may be measured depth, horizontal distance traveled, or another measurement. By adding the offset well depth, the filter out box (708) is created. If the offset well is not in the filtered out box, then no further processing is performed for the offset well and the offset well is removed from consideration.

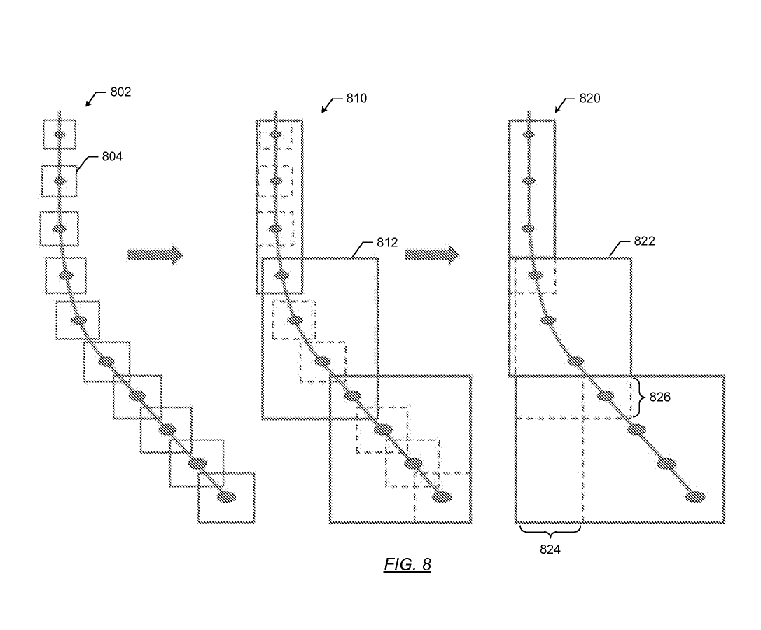

FIG. 8 shows a next stage in filtering. In the next stage, bounding boxes along the trajectory (shown as a line in FIG. 8 connecting ellipses) are created and used to determine whether an intersection exists. Diagram (802) shows an initial stage whereby a single EOU bounding box (e.g., bounding box (804)) is created for each EOU (shown as solid ellipses in FIG. 8). Diagram (810) shows the trajectory with the single EOU bounding boxes combined to create multi-EOU bounding boxes (e.g., multi-EOU bounding box (812)). As shown, each adjacent pair of multi-EOU bounding boxes intersects with respect to a single EOU. Although four single EOU bounding boxes are shown as being combined, fewer or more EOU bounding boxes may be combined without departing from the scope of the collision detection method. Further, the number of EOU's in a multi-EOU bounding box may vary along the length of the trajectory.

Diagram (820) shows the trajectory with the multi-EOU bounding boxes revised into non-intersecting bounding boxes (e.g., bounding box (822)). As shown in diagram (820), section (824) may be added to one bounding box and section (826) may be removed from the other box in an adjacent pair of bounding boxes. Thus, the box shape is preserved with the intersections, while at the same time ensuring that the trajectory is spanned by bounding boxes. Thus, final filtering may be performed to remove offset well trajectories that do not have bounding boxes which intersect with the planned well trajectory.

One or more embodiments may further determine and calculate restricted zones around the offset well. EOUs from both the planned well and the offset well are used to calculate the restricted zone. When the well plan is adjusted to be closer to the offset well, EOU for the planned well will change, and, thus, the restricted zone will also change. To make the restricted zone a good guidance for new well design, the restricted zone change should be minimized when the new plan is adjusted. In other words, for one depth of the offset well, one EOU from the current planned well should be found, which is the best estimate of the threatening EOU when the planed well gets closer to the offset well.

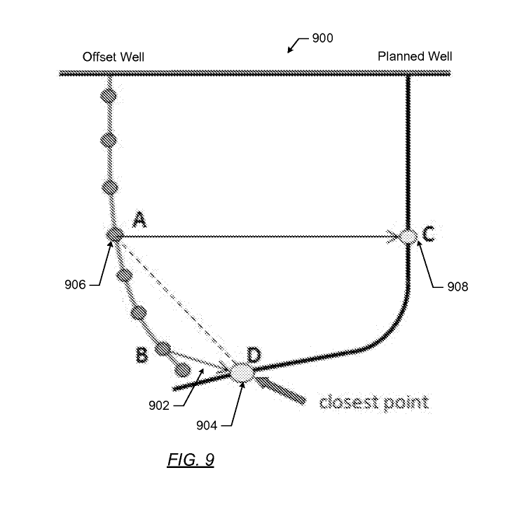

FIG. 9 shows an example diagram (900) in accordance with one or more embodiments. Specifically, FIG. 9 shows an example for searching for the best estimate threatening EOU from the subject well. As shown by ‘BD’ line (902) in FIG. 9, the field management tool may search for the closest EOU when horizontal part of a well is involved, that is, either the subject well or the offset well goes into horizontal part at the depth of the offset well, where the restricted zone is been calculated. For point A (906) on the offset well, the closest point is point D (904) on the planned well. However, point D (904) is actually quite far from point A (906), not making any collision detection concern for point A (906). If the plan is adjusted, the horizontal part is not expected to get close to point A (906), because the horizontal part of a well may be constrained by the reservoir pay zone, while the rig location of the new well may be changed so that the vertical part of the plan will approach the offset well. Thus, for point A (906), point C (908) on the planned well will be searched out for restricted zone calculation. Specifically, because when the vertical part of the subject plan is moving toward the offset well, point C (908) is most likely the point threatening collision with point A (906).

One or more embodiments are directed to a method for calculating and show the restricted pipe around the offset well. At one depth of the offset well, if the well plan designer is concerned about anti-collision at this depth and wants to do a small change of the subject plan, most likely when the plan is moved to other directions around the offset well, the threatening EOU at the subject plan will not change much in both size and orientation.

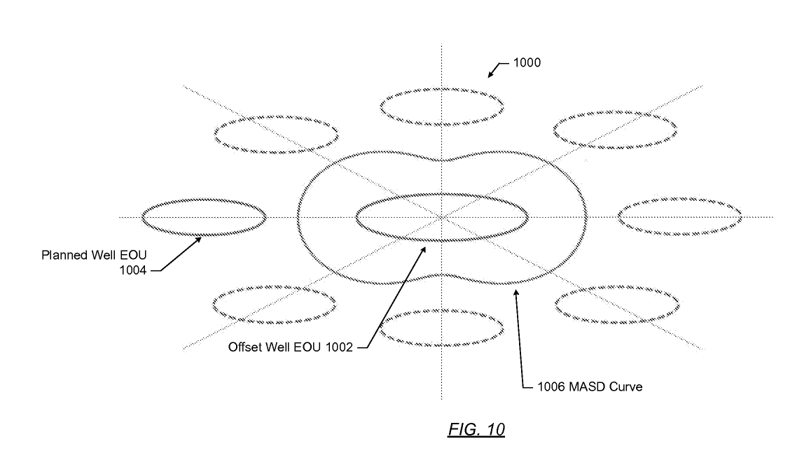

FIG. 10 shows an example of restricted curve at one measured depth of the trajectory assuming the threatening EOU is moved to each direction around the offset well EOU (1002). As shown in the example (1000) in FIG. 10, on the perpendicular plane at the given offset well measured depth, at each direction around the offset well, the threatening planned well EOU (1004), that is selected as described in FIG. 10, is assumed to be moved to each direction around the offset well EOU (1002) as shown by the dotted ellipses in FIG. 10. The MASD points may be calculated and connected at each direction to make the restricted curve (1006) on the plane. Because MASD is dependent on anti-collision rule, the MASD curve (1006) may also be dependent on collision detection rule. If pedal curve method is used, the restricted curve on one plane may look like a pedal curve as shown in FIG. 10. To make 3D restricted zone display, the restricted curves at different depths are connected.

One or more embodiments further include functionality to show restricted zones around offset wells in three dimensional 3D visualization for well path design with anti-collision concern. One or more embodiments display the restricted zones around each offset well leaving the available space outside of restricted zones for the planned well path to go without collision failure. Well plans that intersect with a restricted zone fail collision detection.

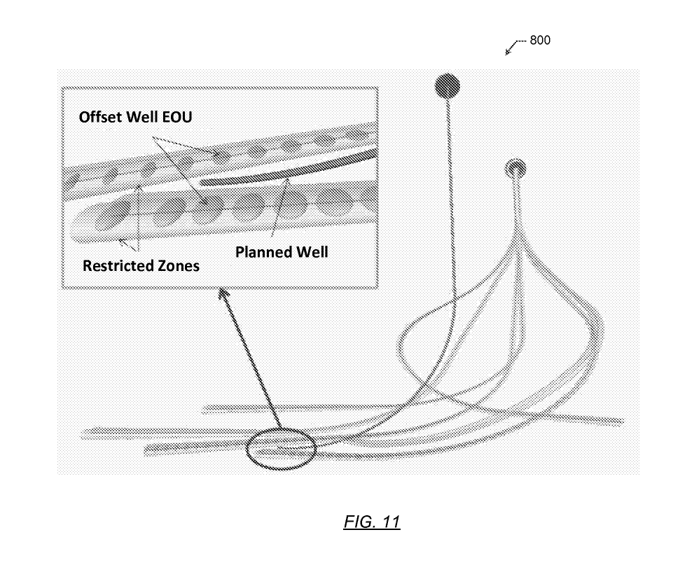

FIG. 11 shows a visualization tool in accordance with one or more embodiments. As shown in FIG. 11, visualization tools may be useful in improving anti-collision analysis efficiency. In the example, no anti-collision failure is reported in accordance with one or more embodiments. However, the planned well goes through a very narrow channel between offset well restricted zones. A small change of the planned well may move the planned well to a much safer state. The three dimensional visualization clarifies how to make the change.

Embodiments may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments. For example, as shown in FIG. 12, the computing system (1200) may include one or more computer processor(s) (1202), associated memory (1204) (e.g., random access memory (RAM), cache memory, flash memory, etc.), one or more storage device(s) (1206) (e.g., a hard disk, an optical drive such as a compact disk (CD) drive or digital versatile disk (DVD) drive, a flash memory stick, etc.), and numerous other elements and functionalities. The computer processor(s) (1202) may be an integrated circuit for processing instructions. For example, the computer processor(s) may be one or more cores, or micro-cores of a processor. The computing system (1200) may also include one or more input device(s) (1210), such as a touchscreen, keyboard, mouse, microphone, touchpad, electronic pen, or any other type of input device. Further, the computing system (1200) may include one or more output device(s) (1208), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (1200) may be connected to a network (1212) (e.g., a local area network (LAN), a wide area network (WAN) such as the Internet, mobile network, or any other type of network) via a network interface connection (not shown). The input and output device(s) may be locally or remotely (e.g., via the network (1212)) connected to the computer processor(s) (1202), memory (1204), and storage device(s) (1206). Many different types of computing systems exist, and the aforementioned input and output device(s) may take other forms.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments.

Further, one or more elements of the aforementioned computing system (1200) may be located at a remote location and connected to the other elements over a network (1212). Further, embodiments may be implemented on a distributed system having a plurality of nodes, where each portion may be located on a different node within the distributed system. In one embodiment, the node corresponds to a distinct computing device. The node may correspond to a computer processor with associated physical memory. The node may correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the collision detection method as disclosed herein.

What is claimed is:

1. A method for collision detection comprising:
identifying a planned trajectory of a planned well;
selecting a plurality of offset wells based on the planned trajectory;
filtering the plurality of offset wells once selected to obtain a plurality of filtered wells, wherein the filtering comprises:
generating a first plurality of three dimensional bounding boxes along the planned trajectory, wherein the first plurality of three dimensional bounding boxes each comprise a first plurality of ellipsoids of uncertainty (EOU) along the planned trajectory;
performing a first removal process comprising for each offset well in a set of unprocessed wells in the plurality of offset wells:
generating a second plurality of three dimensional bounding boxes along an offset trajectory of the offset well, wherein the second plurality of three dimensional bounding boxes each comprise a second plurality of EOU along the offset trajectory, and
filtering the offset well from the plurality of offset wells when the first plurality of three dimensional bounding boxes satisfy a first threshold distance from the second plurality of three dimensional bounding boxes; and
presenting at least a subset of the plurality of filtered wells.

2. The method of claim 1, wherein the first plurality of three dimensional bounding boxes satisfy the first threshold distance when the first plurality of three dimensional bounding boxes intersect with the second plurality of three dimensional bounding boxes.

3. The method of claim 1, wherein selecting the plurality of offset wells based on the offset trajectory comprises:
adding to the plurality of offset wells, each offset well having an offset trajectory within a threshold distance to the planned trajectory.

4. The method of claim 1, wherein filtering comprises:
projecting the planned trajectory onto a first two dimensional plane;
performing, prior to performing the first removal process, a second removal process comprising for each offset well in the plurality of offset wells:
projecting the offset trajectory of the offset well onto a second two dimensional plane, and
removing the offset well from the set of unprocessed wells when the first two dimensional plane satisfies a second threshold distance from the second two dimensional plane.

5. The method of claim 4, wherein the first two dimensional plane satisfies the second threshold distance from the second two dimensional plane when the first two dimensional plane fails to intersect the second two dimensional plane.

6. The method of claim 1, wherein filtering further comprises:
adjusting, prior to filtering the offset well, the first plurality of three dimensional bounding boxes to remove intersections in the first plurality of three dimensional bounding boxes.

7. The method of claim 1, wherein filtering further comprises:
adjusting, prior to filtering the offset well, the second plurality of three dimensional bounding boxes to remove intersections in the second plurality of three dimensional bounding boxes.

8. The method of claim 1, further comprising:
selecting a target offset well from the plurality of filtered wells;
generating a three dimensional restricted zone using the planned well and target offset well; and
presenting a user interface showing the three dimensional restricted zone.

9. The method of claim 8, further comprising:
selecting, for a second EOU in the second plurality of EOU, a first EOU in the first plurality of EOU; and
for each of a plurality of directions, calculating a minimum allowed separation distance (MASD) for the direction, and determining a minimum point in the direction that satisfies the MASD,
joining the minimum points to create a two dimensional restricted zone, wherein the three dimensional restricted zone is generated using the two dimensional restricted zone.

10. The method of claim 9, wherein the first EOU is maintained in a same size and a same orientation as in the first trajectory when calculating the MASD.

11. The method of claim 9,
wherein the first EOU is selected based on being located at a first depth within a threshold distance to a second depth of the second EOU when the second EOU is located at a vertical section of the target offset well, and
wherein the first EOU is selected based on being closest amongst the first plurality of EOU to the second EOU when the second EOU is located at a horizontal section of the target offset well.

12. A system for collision detection comprising:
a data repository for storing well information; and
a trajectory analysis module operatively connected to the data repository and configured to:
identify a planned trajectory of a planned well;
select a plurality of offset wells based on the planned trajectory;
filter the plurality of offset wells once selected to obtain a plurality of filtered wells, wherein the filtering comprises:
generating a first plurality of three dimensional bounding boxes along the planned trajectory, wherein the first plurality of three dimensional bounding boxes each comprise a first plurality of ellipsoids of uncertainty (EOU) along the planned trajectory;
performing a first removal process comprising for each offset well in a set of unprocessed wells in the plurality of offset wells:
generating a second plurality of three dimensional bounding boxes along an offset trajectory of the offset well, wherein the second plurality of three dimensional bounding boxes each comprise a second EOU along the offset trajectory,
filtering the offset well from the plurality of offset wells when the first plurality of three dimensional bounding boxes satisfy a first threshold distance from the second plurality of three dimensional bounding boxes; and
a user interface operatively connected to the data repository and configured to:
present at least a subset of the plurality of filtered wells.

13. The system of claim 12, wherein filtering comprises:
projecting the planned trajectory onto a first two dimensional plane;
performing, prior to performing the first removal process, a second removal process comprising for each offset well in the plurality of offset wells:
projecting an offset trajectory of the offset well onto a second two dimensional plane,
removing the offset well from the set of unprocessed wells when the first two dimensional plane satisfies a second threshold distance from the second two dimensional plane.

14. The system of claim 12, wherein filtering further comprises:
adjusting, prior to filtering the offset well, the first plurality of three dimensional bounding boxes to remove intersections in the first plurality of three dimensional bounding boxes.

15. The system of claim 12, wherein the trajectory analysis module is further configured to:
select a target offset well from the plurality of filtered wells; and
generate a three dimensional restricted zone using the planned well and target offset well, and
wherein the user interface is further configured to show the three dimensional restricted zone.

16. The system of claim 15, wherein the trajectory analysis module is further configured to:
selecting, for a second EOU in the second plurality of EOU, a first EOU in the first plurality of EOU,
for each of a plurality of directions, calculating a minimum allowed separation distance (MASD) for the direction, and determining a minimum point in the direction that satisfies the MASD,
joining the minimum points to create a two dimensional restricted zone, wherein the three dimensional restricted zone is generated using the two dimensional restricted zone, and
wherein the first EOU is maintained in a same size and a same orientation as in the first trajectory when calculating the MASD.

17. The system of claim 9,
wherein the first EOU is selected based on being located at a first depth within a threshold distance to a second depth of the second EOU when the second EOU is located at a vertical section of the target offset well, and
wherein the first EOU is selected based on being closest amongst the first plurality of EOU to the second EOU when the second EOU is located at a horizontal section of the target offset well.

18. A non-transitory computer readable medium comprising computer readable program code for:
identifying a planned trajectory of a planned well;
selecting a plurality of offset wells based on the planned trajectory;
filtering the plurality of offset wells once selected to obtain a plurality of filtered wells, wherein the filtering comprises:
generating a first plurality of three dimensional bounding boxes along the planned trajectory, wherein the first plurality of three dimensional bounding boxes each comprise a first plurality of ellipsoids of uncertainty (EOU) along the planned trajectory;
performing a removal process comprising for each offset well in a set of unprocessed wells in the plurality of offset wells:
generating a second plurality of three dimensional bounding boxes along an offset trajectory of the offset well, wherein the second plurality of three dimensional bounding boxes each comprise a second plurality of EOU along the offset trajectory,
filtering the offset well from the plurality of offset wells when the first plurality of three dimensional bounding boxes satisfy a threshold distance from the second plurality of three dimensional bounding boxes; and
presenting at least a subset of the plurality of filtered wells.

19. The non-transitory computer readable medium of claim 18, further comprising computer readable program code for:
selecting a target offset well from the plurality of filtered wells;
generating a three dimensional restricted zone using the planned well and target offset well; and
presenting a user interface showing the three dimensional restricted zone.

20. The non-transitory computer readable medium of claim 18, further comprising computer readable program code for:
selecting, for a second EOU in the second plurality of EOU, a first EOU in the first plurality of EOU; and
for each of a plurality of directions, calculating a minimum allowed separation distance (MASD) for the direction, and determining a minimum point in the direction that satisfies the MASD,
joining the minimum points to create a two dimensional restricted zone, wherein the three dimensional restricted zone is generated using the two dimensional restricted zone, and
wherein the first EOU is maintained in a same size and a same orientation as in the first trajectory when calculating the MASD.
